(19) United States
(12) Patent Application Publication
(10) Pub. No.: US 2013/0036903 A1
(43) Pub. Date: Feb. 14, 2013

(54) Vortex turbulence inducing piston

(71) Applicants: Anthony Scott Daniels, Ann Arbor, MI (US); Susanne Marie Daniels, Ann Arbor, MI (US)

(72) Inventors: Anthony Scott Daniels, Ann Arbor, MI (US); Susanne Marie Daniels, Ann Arbor, MI (US)

(21) Appl. No.: 13/506,955

(22) Filed: May 29, 2012

Related U.S. Application Data
(60) Provisional application No. 61/574,671, filed on Aug. 8, 2011.

(51) Int. Cl. F16J 1/09

(52) U.S. Cl. 92/172

(57) ABSTRACT

A piston which has alternating high and low regions on the compression face for the purpose of inducing turbulent mixing of the fluid being compressed is described. This piston design is intended for, but not limited to, use in internal combustion engines, where the turbulence induced better mixes the fuel/air charge during compression before ignition.

### REFERENCE LIST

U.S. PATENT DOCUMENTS REFERENCES

| Ref# | U.S. Patent # | Date | Inventor | Title | Type |
|---|---|---|---|---|---|
| R1 | 4,013,057 | Mar. 22, 1977 | Guenther | Piston Assembly | Conical Combustion |
| | | | | | Bowl |
| R2 | 4,016,841 | Apr. 12, 1977 | Karaba | Variable Compression Ratio Piston | Flat Combustion |
| | | | | | Surface |
| R4 | 4,068,629 | Jan. 17, 1978 | Hooper | Stepped Piston Two Stroke | Cylindrical Stepped |
| | | | | Engines | Piston |
| R5 | 4,075,934 | Feb. 28, 1978 | Wacker | Piston for Internal Combustion | Convex Domed |
| | | | | Engine | Combustion Surface |
| R7 | 4,129,108 | Dec. 12, 1978 | Elsbett | Piston for Internal Combustion | Spherical |
| | | | | Engine | Combustion Bowl |
| R8 | 4,142,484 | Mar. 06, 1979 | Buhl | Piston for Internal Combustion | Cylindrical |
| | | | | Engine | Combustion Bowl |
| R14 | 4,237,827 | Dec. 09, 1980 | Hamai | Swirl Chamber Diesel Engine With | Double Cylinder |
| | | | | Piston Formed with Curved | Combustion Bowl |
| | | | | Groove at its Crown | |
| R37 | 4,522,163 | Jun. 11, 1985 | Hooper | Stepped Piston and Stepped Piston | Stepped Piston |
| | | | | Engine | |
| R113 | 5,123,386 | Jun. 23, 1992 | Wakita | Internal Combustion Engine and its | Shallow Cylindrical |
| | | | | Piston | Combustion Bowl |
| R120 | 5,239,959 | Aug. 31, 1993 | Loth | Isolated Combustion and Diluted | Conical Combustion |
| | | | | Expansion Piston Engine | Chamber |
| R163 | 6,073,602 | Jun. 13, 2000 | Muta | Piston for Internal Combustion | Stepped |
| | | | | Engine | Combustion Surface |
| R164 | 6,076,506 | Jun. 20, 2000 | Berlinger | Piston for Use in an Engine | Flat Combustion |
| | | | | | Surface |
| R165 | 6,112,715 | Sep. 05, 2000 | Nigro | Piston for an Internal Combustion | Conical Combustion |
| | | | | Engine | Bowl |
| R166 | 6,129,065 | Oct. 10, 2000 | Ueda | Piston for a Cylinder Injection | Spherical |
| | | | | Engine | Combustion Bowl |
| R167 | 6,152,101 | Nov. 28, 2000 | Parsi | Piston for an Internal Combustion | Conical and |
| | | | | Engine having a Re-Entrant Type | Cylindrical |
| | | | | Combustion Bowl | Combustion Bowls |
| R168 | 6,164,249 | Dec. 26, 2000 | Honold | Piston for an Internal Combustion | Shallow Cylindrical |
| | | | | Engine | Combustion Bowl |
| R169 | 6,178,942 | Jan. 20, 2001 | Di Priolo | Piston Configuration for Reducing | Cylindrical |
| | | | | Smoke and Particulate Emissions | Combustion Bowl |
| | | | | from Direct Injected Engines | |
| R204 | 6,705,281 | Mar. 16, 2004 | Okamura | Piston for an Internal Combustion | Shallow |
| | | | | Engine | Asymmetric |
| | | | | | Cylindrical |
| | | | | | Combustion Bowl |
| R205 | 6,729,291 | May 04, 2004 | Scharp | Multipart Cooled Piston for an | Conical Combustion |
| | | | | Internal Combustion Engine | Bowl |
| R217 | 6,910,455 | Jun. 28, 2005 | Sczepanski | Spark Ignition Engine with | Elliptical |
| | | | | Shallow Bowl-In-Piston Geometry | Combustion Bowl |
| R245 | 7,415,961 | Aug. 26, 2008 | Chen | Piston for Internal Combustion | Domed Combustion |
| | | | | Engine Compressor or the Like | Surface |
| R246 | 7,421,782 | Sep. 09, 2008 | Otaka | Method for Manufacturing Internal | Cylindrical |
| | | | | Combustion Engine Piston | Combustion Bowl |
| R247 | 7,464,684 | Dec. 16, 2008 | Scharp | Composite Piston for an Internal | Conical Combustion |
| | | | | Combustion Engine | Bowl |
| R248 | 7,467,613 | Dec. 23, 2008 | Taylor | Internal Combustion Engine with | Flat Combustion |
| | | | | Cylinder and Piston Having a Dual | Surface |
| | | | | Combustion Stroke | |
| R270 | 7,856,958 | Dec. 28, 2010 | Tachibana | Piston for Internal Combustion | Shallow Spherical |
| | | | | Engine and Internal Combustion | Cylindrical |
| | | | | Engine Using the Piston | Combustion Bowl |
| R271 | 7,861,679 | Jan. 04, 2011 | Lemke | Cylinder and Piston Assemblies for | Trapezoidal |
| | | | | Opposed Piston Engines | Cylindrical |
| | | | | | Combustion Bowl |
| R278 | 7,946,216 | May 24, 2011 | Scharp | Two-Part Piston for an Internal | Conical Combustion |
| | | | | Combustion Engine | Bowl |
| R287 | Patd377493 | Jan. 21, 1997 | Oda | Piston | Domed Combustion |
| | | | | | Surface with |
| | | | | | Elliptical |
| | | | | | Combustion Bowl |
| R288 | Patd609247 | Feb. 02, 2010 | Naegele | Piston with X-Shaped Grove in the | Cylindrical |
| | | | | Skirt | Combustion Bowl |

U.S. PROVISIONAL PATENT APPLICATION

| | | | | | |
|---|---|---|---|---|---|
| R290 | Provisional | Jun. 09, 2011 | Daniels and | Opposed Piston Split Shaft Single | U.S. Pat. No. 61/520,367 |
| | Patent | | Daniels | Charge Engine | |
| | Application | | | | |
| R291 | Provisional | Aug. 08, 2011 | Daniels and | Vortex Turbulence Inducing Piston | U.S. Pat. No. 61/574,671 |
| | Patent | | Daniels | | |
| | Application | | | | |

OTHER PUBLICATIONS

| | |
|---|---|
| R292 | Daniels, Anthony. “Turbulent Mixing Piston” Anthony Scott Daniels Invention Log 2. Date Apr. 26, 2009. - |
| | not published |

### DRAWINGS SECTION

| Drawing | |
|---|---|
| Symbol | Drawing Feature |
| C01 | Vortex Turbulence Inducing Piston |
| C02 | Vortex Inducing Compression Surface |
| C03 | Alternating high and low regions of compression surface |
| C04 | Piston Connector Rod |
| C05 | Piston O-Rings |
| C06 | Crank shaft |
| C07 | Cylinder Wall |
| C08 | Inner Crank Shaft Housing |
| C09 | Outer Crank Shaft Housing |
| C10 | Transmission Casing |
| C11 | Opposed Piston Split Shaft Single Charge (OPS3C) Engine |

### BACKGROUND OF INVENTION

1. Field of Invention

The field of invention relates generally to piston design for Internal Combustion Engines (ICE).

2. Description of Prior Art

The internal combustion engine has been around for over a century, powering mechanical equipment in just about every aspect of our lives from transportation to electrical power generation to household devices. There have been many notable improvements to ICE designs to improve either power output and/or efficiency of the devices. At the core of the ICE is the piston, which directly interfaces with the combustion charge and pushes the connecting rods which turn the crank shaft. Because the piston assembly is the means in which the chemical combustion energy is translated into mechanical energy there has been a lot of effort in piston design to improve the generation of that mechanical energy. Part of that design effort has been focused on the combustion surface, or the face of the piston that is exposed directly to the combustion charge. Designs have varied greatly in the past decades. However they typically fall into the following categories:
Flat Combustion Surface [R2, R164, R248]
Combustion Bowl [R1, R4, R166, R204, R270, R278]
Domed Combustion Surface [R5, R287]
Stepped Piston [R37, R163]

The flat combustion surface is the simplest of the designs, often chosen simple manufacturing reasons. The combustion bowl designs (conical, cylindrical, spherical, etc.) have a bowl shaped recess in the middle of the piston where the combustion charge is injected and ignited. The domed combustions surfaces are very infrequently used because they provide no mechanical advantage over the flat combustion surface. Similarly the stepped piston designs are also rare in ICE use. The goal of Vortex Turbulence Inducing Piston is to improve the combustion process efficiency in generating the mechanical energy of the engine.

### BRIEF SUMMARY OF THE INVENTION

The Vortex Turbulence Inducing Piston (VTI Piston) is a piston which has alternating high and low regions on the compression face for the purpose of inducing turbulent mixing of the fluid being compressed. This piston design is intended for, but not limited to, use in internal combustion engines, where the turbulence induced better mixes the fuel/air charge during compression before ignition. This turbulence induced mixing improves the combustion process and the efficiency of the engine.

### BRIEF DESCRIPTION OF THE DRAWINGS

The following is a brief description of the drawings enclosed in this document. For a complete understanding of the content of these drawings and the objects of the invention, please refer to the detailed description of the invention in this document.

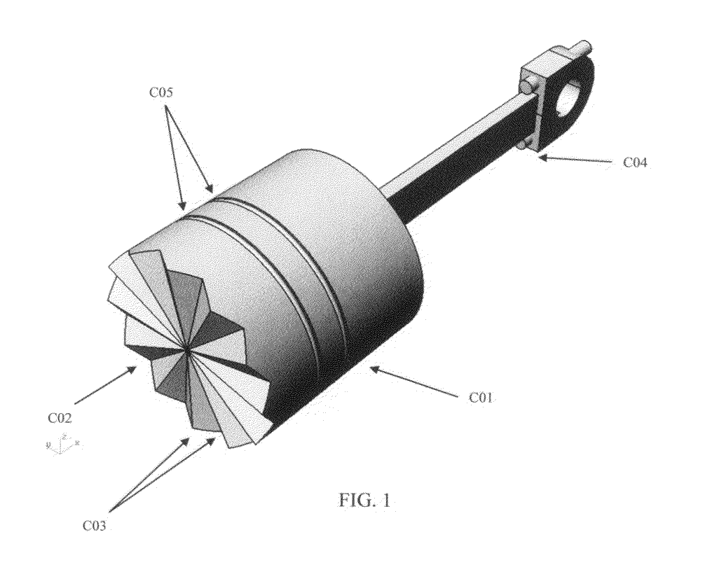

FIG. 1) is a front isometric view of the VTI Piston and supporting piston connector rod.

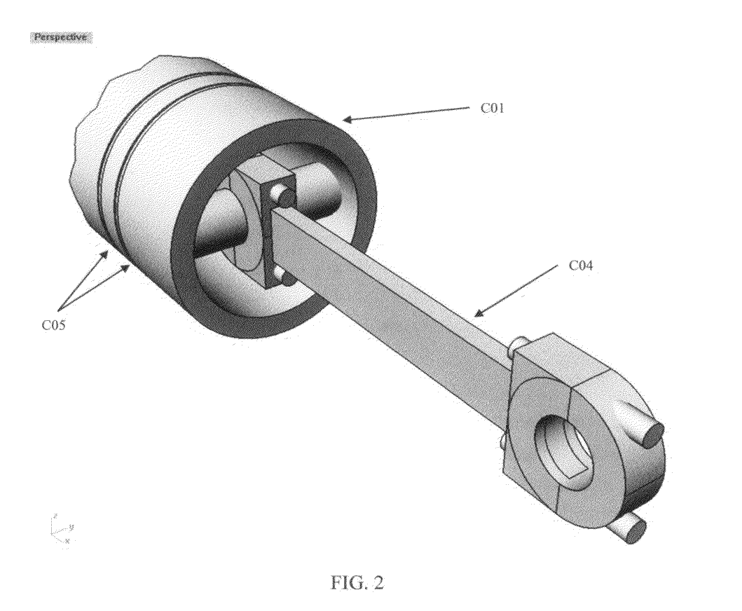

FIG. 2) is a back isometric view of the VTI Piston and supporting piston connector rod.

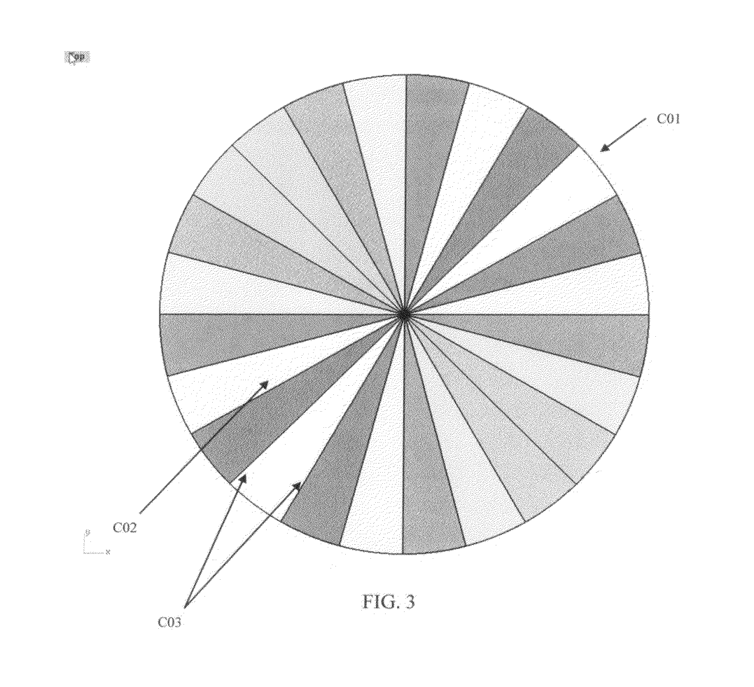

FIG. 3) is a top view of the VTI Piston's compression face, highlighting the alternating high and low surface features which improve turbulent mixing of the fuel/air charge.

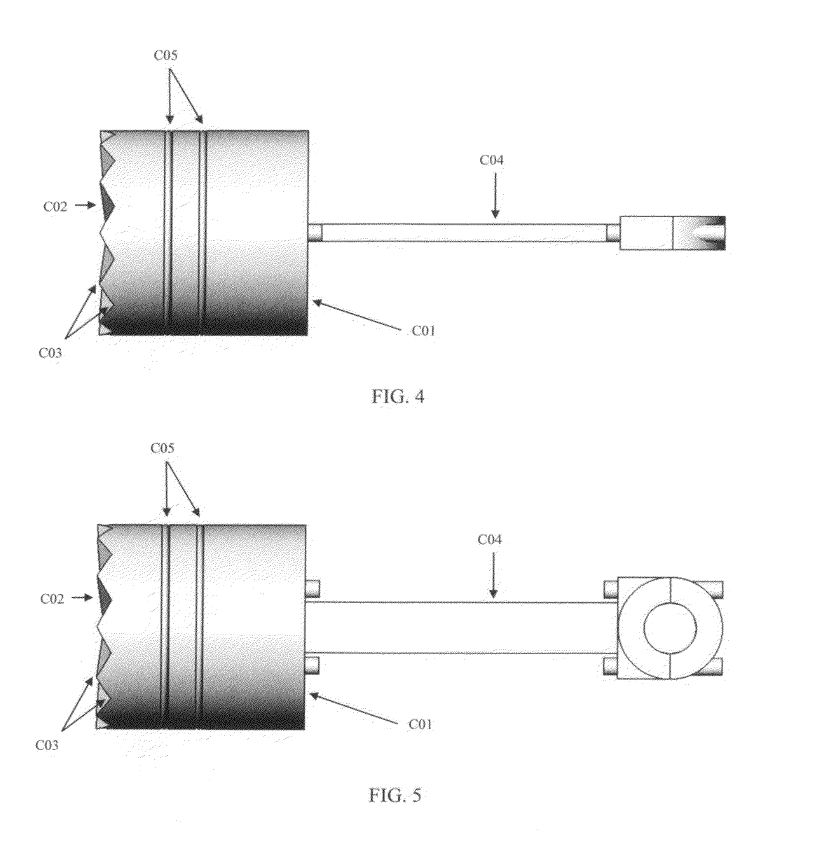

FIG. 4) is a side view of the VTI Piston and supporting piston connector rod.

FIG. 5) is a side view of the VTI Piston and supporting piston connector rod.

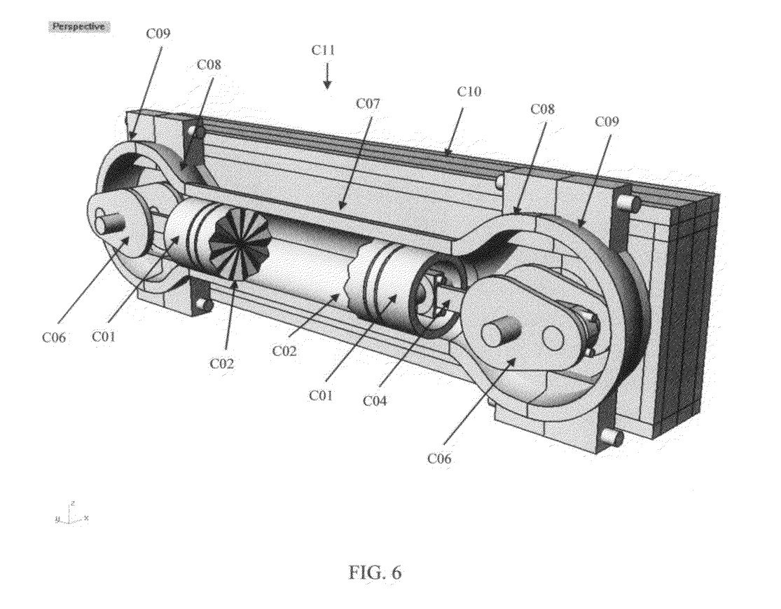

FIG. 6) is a front isometric view of the VTI Piston installed in an OPS3C Engine. The view is a sectional view of the cylinder, showing the internals of the engine including the two VII Pistons installed and supporting crank shaft assemblies.

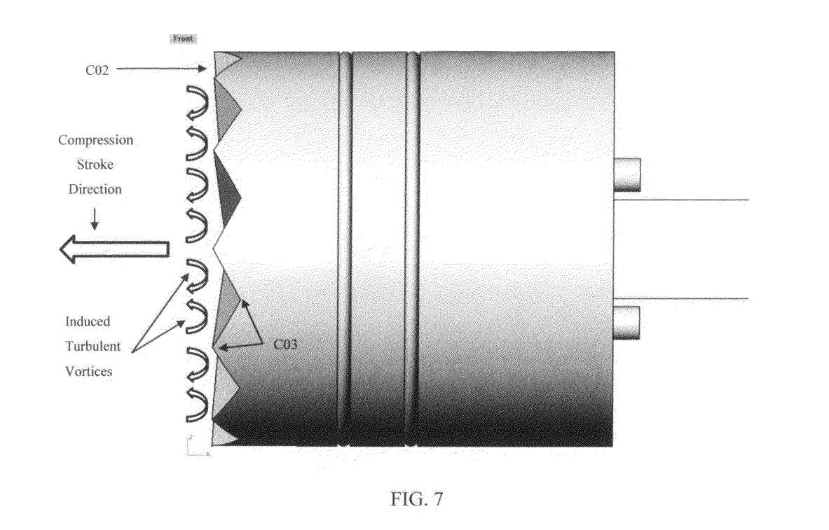

FIG. 7) is a side view illustration of the compression stroke of the VTI Piston and the turbulent vortices that are formed which induce better mixing of the fuel/air charge.

### DETAILED DESCRIPTION OF THE INVENTION

The Vortex Turbulence Inducing Piston (VTI Piston)[C01] is a piston which has alternating high and low regions [C02, C03] on the compression face for the purpose of inducing turbulent mixing of the fluid being compressed. This piston design is intended for, but not limited to, use in internal combustion engines, where the turbulence induced better mixes the fuel/air charge during compression before ignition. This turbulence induced mixing improves the combustion process and the efficiency of the engine.

In the example design shown in FIGS. 1-7, the symmetric high and low regions [C03] on the compression face [C02] create a series of concentric triangular facets. The leading edges of these facets, during the compression phase of the piston cycle, cause turbulent vortices (FIG. 7) to be created in the channels between peaks. In addition the downward and outward slope of the channels between the peak ridges allows for the prevention of residue buildup on the piston compression face. Because the proposed design is concentrically symmetric, there are no induced torque forces on the piston compression face.

One of the primary benefits of the VTI Piston is that it is designed to be installable on any Internal Combustion Engine (ICEs). This includes the aftermarket installation on existing ICEs for the purposes of improving fuel efficiency of existing engines. The VTI Piston is designed to attach to the existing connector rod [C04]. FIG. 6 shows a pair of VTI Pistons installed in an Opposed Piston Split Shaft Single Charge (OPS3C) engine [C11]. The sectional view drawing has half of the cylinder assembly [C07] removed to illustrate how the VTI Pistons would look installed.

Now that a detailed description has been addressed, the claimed invention is:

1. A piston which has alternating high and low regions on the compression face for the purpose of inducing turbulent mixing of the fluid being compressed.
